(19) United States
(12) Patent Application Publication
(10) Pub. No.: US 2026/0228212 A1
(43) Pub. Date: Aug. 6, 2026

(54) LAZY AND DEMAND-DRIVEN SQL QUERY GENERATION AND OPTIMIZATION

(71) Applicant: Cisco Technology, Inc., San Jose, CA (US)

(72) Inventors: Anand Raghavan, Santa Clara, CA (US); Ashish Kundu, Milpitas, CA (US)

(73) Assignee: Cisco Technology, Inc., San Jose, CA (US)

(21) Appl. No.: 19/047,484

(22) Filed: Feb. 6, 2025

(51) Int. Cl. G06F 16/242

(52) U.S. Cl. CPC G06F 16/2448

(57) ABSTRACT

In one implementation, a device obtains information regarding a database. The device uses, based on the information regarding the database, an artificial intelligence model to generate a set of potential queries that could be processed by the database. The device modifies a query sent for processing by the database based on the set of potential queries, to form a valid query. The device sends the valid query to the database for processing.

### TECHNICAL FIELD

The present disclosure relates generally to lazy and demand-driven Structured Query Language (SQL) query generation and optimization.

### BACKGROUND

The Structured Query Language (SQL) is widely used to interact with data stored in databases, such as by retrieving stored data that matches the parameters of a SQL query. However, constructing a valid SQL query can be challenging for a typical end user. This is because doing so requires both knowledge of the syntax of SQL itself and knowledge of the underlying database (e.g., table names, row names, etc.).

With the advancements in artificial intelligence (AI), there have also been some recent efforts to extend natural language (NL) models to the task of generating SQL queries. Doing so would allow an end user to issue a query using their natural language, rather than in SQL. For instance, a user may simply ask the system, “how many employees of the company are located in Delaware?” The model would then convert the input request into a corresponding SQL query for processing.

While NL-to-SQL systems are promising, generating accurate SQL queries using AI is still computationally expensive. Indeed, producing a model that is capable of understanding a wide variety of natural language inputs and converting them into valid SQL requests often requires iteratively fine tuning the model until it achieves an acceptable degree of accuracy.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a generative model;

FIG. 4 illustrates an example architecture for an artificial intelligence (AI) agent;

FIG. 5 illustrates an example of the generation of potential SQL queries for a database;

FIG. 6 illustrates an example of updating an approximate SQL query;

FIG. 7 illustrates an example of using subquery feedback to generate a SQL query; and

FIG. 8 illustrates an example of a simplified procedure for lazy and demand-driven SQL query generation and optimization, in accordance with one or more implementations described herein.

### DESCRIPTION OF EXAMPLE IMPLEMENTATIONS

### Overview

According to one or more implementations of the disclosure, a device obtains information regarding a database. The device uses, based on the information regarding the database, an artificial intelligence model to generate a set of potential queries that could be processed by the database. The device modifies a query sent for processing by the database based on the set of potential queries, to form a valid query. The device sends the valid query to the database for processing.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

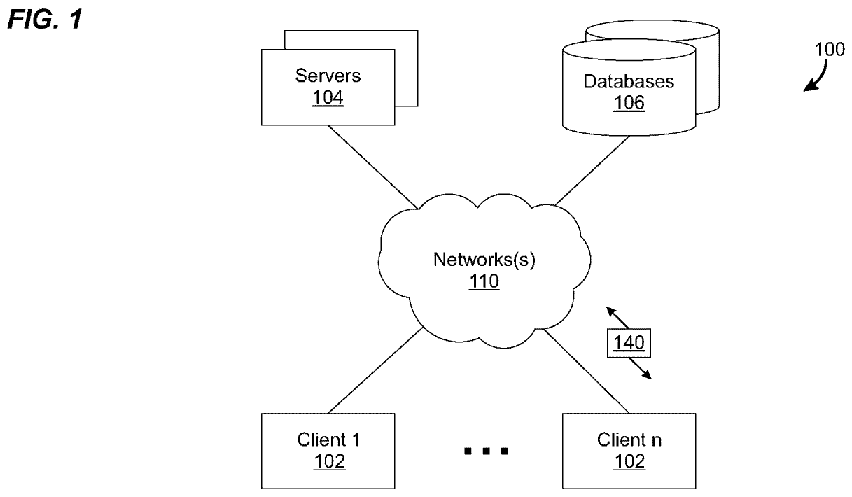

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IOT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (Saas) over a network, such as the Internet.

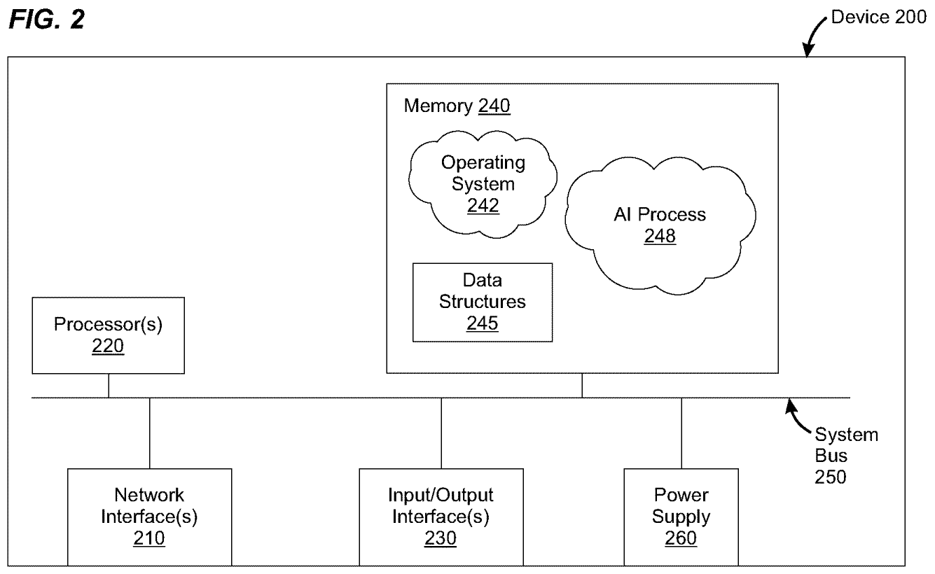

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning (ML). In general, AI/ML is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ one or more supervised, unsupervised, or semi-supervised AI/ML models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/ML techniques that the AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/ML models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs) and other foundation models, diffusion models, transformer models, and the like.

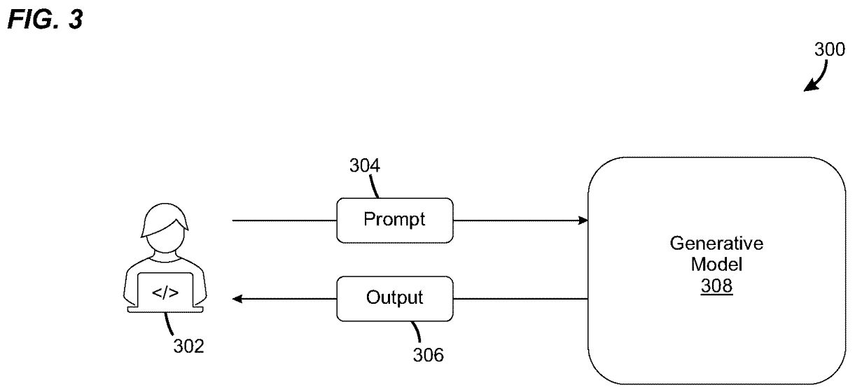

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

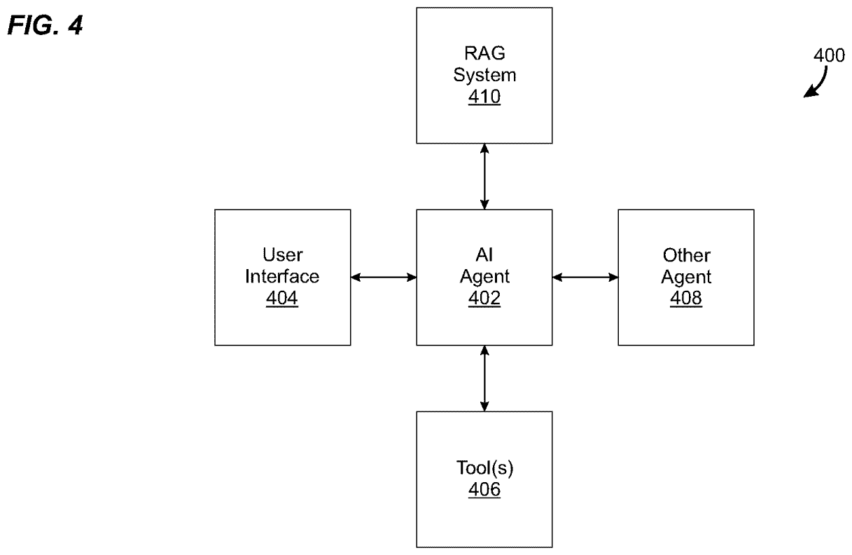

FIG. 4 illustrates an example architecture 400 for an AI agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, with the advancements in AI, there have also been some recent efforts to extend natural language (NL) models to the task of generating Structured Query Language (SQL) queries used to interact with the data stored in a database. As would be appreciated, “SQL query” herein is used in a generic fashion to refer to any input statement written in SQL for processing by a database, regardless of whether the statement is used to retrieve data (e.g., to edit data, delete data, modify the structure of the database, etc.).

Doing so would allow an end user to issue a query using their natural language, rather than in SQL. For instance, a user may simply ask the system, “how many employees of the company are located in Delaware?” The model would then convert the input request into a corresponding SQL query for processing.

For instance, an NL-to-SQL system could be implemented using any or all of the components of architecture 400 shown in FIG. 4. In such an implementation, a user may provide a natural language query via user interface 404. In turn, AI agent 402 may convert the natural language query into a SQL query for execution against a database that it may access via tool 406. To do so, the model(s) associated with AI agent 402 may be trained using a training dataset that comprises natural language queries and their corresponding SQL queries. In other instances, AI agent 402 could interface with a non-AI engine configured to perform NL-to-SQL translations (e.g., based on heuristics, static rules, etc.) via tools 406.

While NL-to-SQL systems are promising, generating accurate SQL queries using AI is still computationally expensive. Indeed, producing a model that is capable of understanding a wide variety of natural language inputs and converting them into valid SQL requests often requires iteratively fine tuning the model until it achieves an acceptable degree of accuracy.

### Lazy and Demand-driven SQL Query Generation and Optimization

The techniques introduced herein provide for improved NL-to-SQL translation, allowing end users to issue database queries using natural language. In some aspects, the techniques herein leverage generative AI to generate and/or optimize SQL queries derived from natural language. Said differently, the techniques herein allow for the system to generate semantically correct SQL queries using an LLM/agent-aware database. To do so, the system leverages knowledge of the database schema and use cases already ingested into the LLM/agent(s) using finetuning, RAG, and/or a mixture of experts.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device obtains information regarding a database. The device uses, based on the information regarding the database, an artificial intelligence model to generate a set of potential queries that could be processed by the database. The device modifies a query sent for processing by the database based on the set of potential queries, to form a valid query. The device sends the valid query to the database for processing.

Operationally, the techniques herein take the database state into account when performing NL-to-SQL translation, according to various implementations. More specifically, the techniques herein allow for the generation of SQL queries in a lazy and demand-driven manner: based on the knowledge of the database schema, and other context information in a RAG, a subquery SQᵢ is generated from a natural language query D or a subset of the natural language query SDⱼ. The query engine then processes SQᵢ and sends a control response Rₓ back to G or the agents Aₖ. Then, the control response Rₓ leads to generate SQᵢ₊₁ as the next subquery.

More specifically, in some implementations, one or more agents may generate different subqueries and combine them to create an intermediate subquery or the final query using a chain-of-thoughts manner.

In further implementations, the system may also make use of RAG about the database and/or other context information, to generate the SQL query.

In addition, the SQL query need not be generated fully, but some subqueries generated earlier can be reused via query caching. Further, subquery results need not be computed as those queries are already computed based on cached queries.

In some implementations, the system may use generative AI to generate queries and query results based on recent execution of similar subqueries and state of the database did not change with respect to these queries and their data. If a query will result in no result or fail in its processing, it is better to send that result out after processing only some subqueries or not processing at all and such generation of responses can be automated.

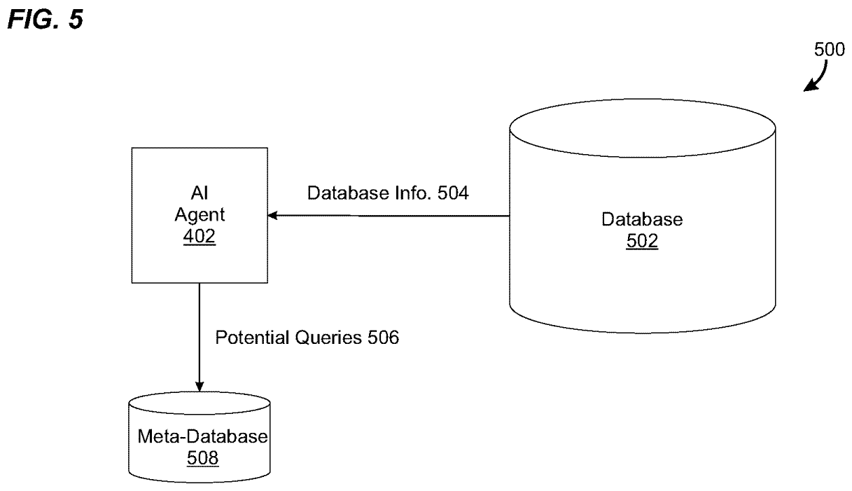

FIG. 5 illustrates an example 500 of the generation of potential SQL queries for a database, according to various implementations, according to various implementations. As shown, assume AI agent 402 is in communication with a database 502.

During execution, AI agent 402 may take as input the database information 504 regarding database 502. In some instances, AI agent 402 may do so on a pull basis by requesting database information 504 from database 502. In other cases, AI agent 402 may do so on a push basis whereby database 502 provides database information 504 to AI agent 402 without first receiving a request to do so. According to various implementations, database information 504 may include any or all of the following:
Information regarding the schema of database 502 (e.g., its tables, columns, relations, etc.).
Information regarding any integrity constraints of database 502 (e.g., ones that require a unique value, a non-null value, a default value if one is not specified, other criteria, etc.).
Any other information regarding the state of database 502 that could affect the processing of a SQL query.

Based on database information 504, AI agent 402 may generate, or otherwise pre-populate, a meta-database 508 that stores potential queries 506 for database 502. Note that potential queries 506 may also include subqueries, as well, in some implementations.

More specifically, AI agent 402 may leverage its one or more generative AI models (e.g., an LLM, etc.) and its knowledge about database 502 from database information 504 to devise a pool of (sub)queries that would be valid with respect to database 502. Indeed, not all (sub)queries possible with respect to database 502 are valid, given the integrity constraints, relations, etc. actually in use within database 502.

As would be appreciated, meta-database 508 can take various forms, depending on the desired implementation. In one implementation, meta-database 508 may be a separate database from that of database 502. In another implementation, meta-database 508 may be stored within database 502 itself. In a further implementation, meta-database 508 may take the form of a vector database that stores the potential (sub)queries as embeddings.

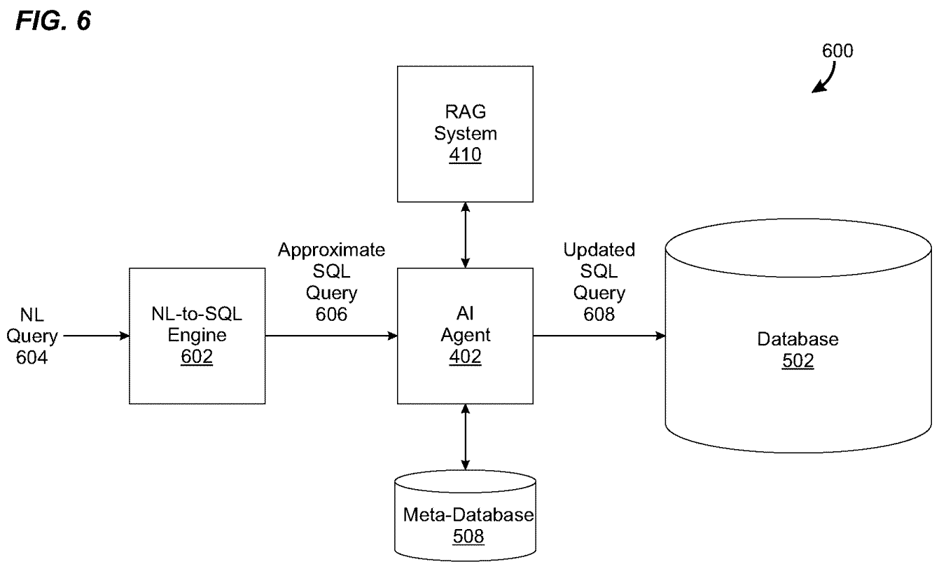

FIG. 6 illustrates an example 600 of updating an approximate SQL query, according to various implementations. As shown, assume now that AI agent 402 has populated meta-database 508 with a set of (sub)queries that are possible for execution by database 502, in accordance with the techniques described above. Also as shown, assume that the system includes an NL-to-SQL engine 602 that is configured to translate natural language queries into SQL queries.

Typically, NL-to-SQL engine 602 may take the form of a generative AI model that AI agent 402 is able to access. However, the techniques herein are not limited as such and can be applied to non-AI based NL-to-SQL generation techniques, as well, in further implementations.

During execution, the system may proceed as follows:

First, a user or other requester (e.g., another agent, etc.) may issue NL query 604 with respect to data stored in database 502. A defining characteristic of natural langue is that such a language evolves naturally through human interactions (e.g., speaking, writing and reading, etc.). For instance, English, French, Italian, Japanese, Arabic, Chinese, and the like, are all examples of natural languages.

By way of example, a simple natural language query may be “how many employees of the company are located in Delaware?” Such a query, though, may seek data that spans multiple tables within database 502 (e.g., from a first table of employees and their employee IDs, from a second table that stores employee addresses, etc.), as well as some additional processing of that data (i.e., to determine a count of matching employees).

In turn, NL-to-SQL engine 602 may devise an approximate SQL query 606 based on NL query 604. Here, the SQL query from NL-to-SQL engine 602 is considered to be approximate, as it may be any or all of the following: syntactically incorrect, semantically incorrect, or inefficient. In the case of NL-to-SQL engine 602 relying on AI model, for instance, this can be due to a lack of finetuning, a lack of training data available regarding database 502, changes made to database 502 after the model was created, or other such factors.

In various implementations, AI agent 402 may use the (sub)queries in meta-database 508 to assess approximate SQL query 606 and, if necessary, make changes to it, resulting in updated SQL query 608. To do so, AI agent 402 may determine whether approximate SQL query 606 matches any of the possible queries stored in meta-database 508. If AI agent 402 finds a match, then it may simply pass approximate SQL query 606 onward to database 502 for execution (e.g., by its SQL processing engine).

However, if AI agent 402 is unable to find a match between approximate SQL query 606 and any query in meta-database 508, this could mean that NL-to-SQL engine 602 has generated an incorrect SQL query. In turn, in various implementations, AI agent 402 may simply replace approximate SQL query 606 with the nearest matching query from meta-database 508 as updated SQL query 608.

In other implementations, AI agent 402 may leverage its generative AI model(s) to generate updated SQL query 608. To do so, the model may take as input approximate SQL query 606 (or NL query 604 itself), as well as the information from meta-database 508, to produce updated SQL query 608. In one implementation, meta-database 508 could even be integrated into RAG system 410, thereby providing context to the model of AI agent 402 regarding database 502. For instance, meta-database 508 could be stored as part of RAG system 410, representing the potential queries as abstract syntax trees (ASTs), that RAG system 410 could then use to provide context to the AI model(s) about possible correct SQL (sub)queries for database 502 when asking it to assess approximate SQL query 606.

In some implementations, approximate SQL query 606 could be converted into an embedding and the top k-number of potential queries could be retrieved, based on their semantic similarity, to determine the ‘best’query for use as updated SQL query 608. More specifically, when a user sends in a natural language query, the LLM or other model underlying NL-to-SQL engine 602 may generate a SQL query that may not be fully accurate. In turn, AI agent 402 may vectorize this query and compare it with the embeddings that are precached (e.g., in meta-database 508), to identify the top k-number of embeddings that are closest to what the user asked.

Regardless, once AI agent 402 has generated updated SQL query 608, it may provide updated SQL query 608 to database 502 for processing and return the results to the requester of NL query 604. In some instances, AI agent 402 may also use its generative AI model to generate a final answer for the requester, based on the results of updated SQL query 608 (e.g., to convert the result into sentence or paragraph form, add context to it, etc.).

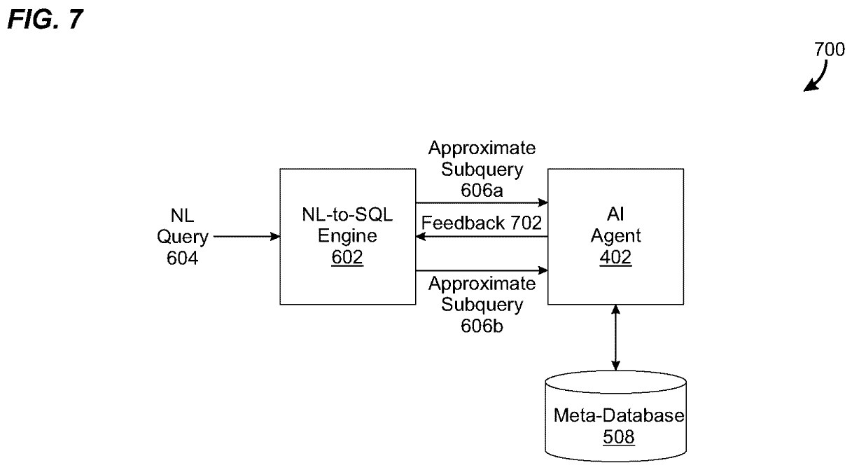

In further implementations, the system may instead be configured to generate and assess subqueries based on NL query 604, to formulate updated SQL query 608. An example of such an implementation is shown in FIG. FIG. 7 illustrates an example 700 of using subquery feedback to generate a SQL query, according to various implementations.

As shown in FIG. 7, rather than NL-to-SQL engine 602 generating a full SQL query from NL query 604, an alternate approach is for it to generate approximate subqueries for AI agent 402 to assess, based on meta-database 508. Here, NL-to-SQL engine 602 may operate in conjunction with AI agent 402 in a chain-of-thought manner, to generate subqueries that can be combined into the final SQL query for processing by the database.

For instance, NL-to-SQL engine 602 may first generate an approximate subquery 606a from NL query 604. In turn, AI agent 402 may assess approximate subquery 606a based on the (sub)queries in meta-database 508 and determine whether any changes need to be made to it. For instance, AI agent 402 may correct any syntactic errors, etc. within approximate subquery 606a.

In some implementations, AI agent 402 may also provide feedback 702 regarding its assessment of approximate subquery 606a back to NL-to-SQL engine 602. Such feedback may indicate any corrections that AI agent 402 made or any other information that NL-to-SQL engine 602 may use to generate the next subquery, approximate subquery 606b. The two may work in conjunction together to generate different subqueries and combine them to form an intermediate subquery in a chain-of-thought manner, or even the final SQL query for processing by database 502.

In some instances, AI agent 402 may provide feedback 702 to a user (e.g., via user interface 404) for review. Doing so allows a database administrator, database engineer, or other interested user to assess the (sub)queries generated by NL-to-SQL engine 602.

The result of this lazy and demand-driven generation of SQL queries reduces the burden on NL-to-SQL engine 602 to generate a complete and correct SQL query based on NL query 604.

As would be appreciated, further implementations provide for AI agent 402 to take the form of multiple agents that operate in conjunction with one another to perform the functions of AI agent 402. In another implementation, the techniques herein could be implemented directly using an LLM or other generative AI model, rather than AI agent 402. In a further implementation, a mixture-of-experts (MoE) model could be used in place of AI agent 402 that relies on multiple LLMs or other models.

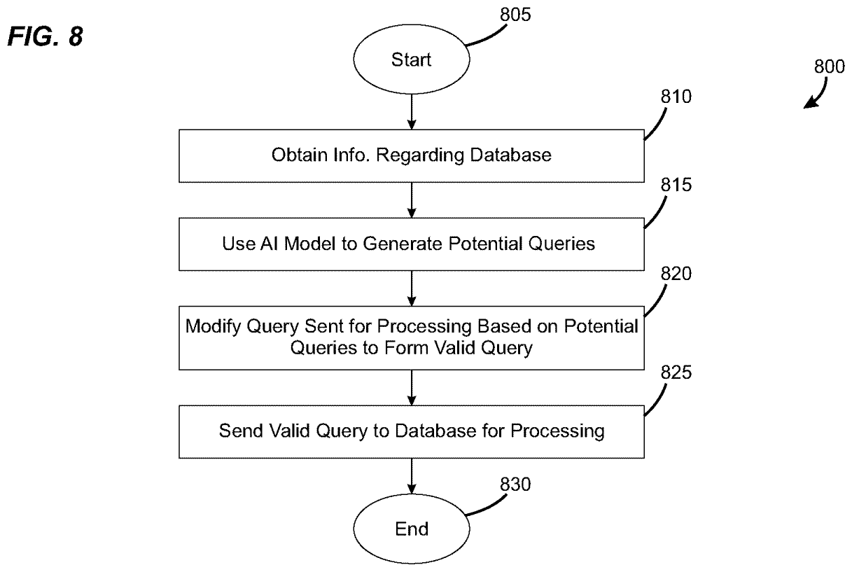

FIG. 8 illustrates an example of a simplified procedure for lazy and demand-driven SQL query generation and optimization, in accordance with one or more implementations described herein. For example, a non-generic, specifically configured device (e.g., device 200), may perform procedure 800 (e.g., a method) by executing stored instructions (e.g., AI process 248). The procedure 800 may start at step 805, and continues to step 810, where, as described in greater detail above, the device (e.g., a controller, server, etc.) may obtain information regarding a database. In various implementations, the information regarding the database comprises schema information for the database or an integrity constraint used in the database.

At step 815, as detailed above, the device may use, based on the information regarding the database, an artificial intelligence model to generate a set of potential queries that could be processed by the database. In some implementations, the artificial intelligence model comprises a large language model (LLM). In one implementation, the device executes an agent to interact with the artificial intelligence model.

At step 820, the device may modify a query sent for processing by the database based on the set of potential queries, to form a valid query, as described in greater detail above. In various implementations, the query sent for processing by the database comprises a Structured Query Language (SQL) statement. In some cases, the query was sent by a user interface for processing by the database. In another implementation, the query was generated by a natural language to Structured Query Language (SQL) converter. In some cases, the device modifies the query by using chain-of-thought processing to assess a subquery of the query using the set of potential queries. In further cases, the device modifies the query in part by providing the set of potential queries to the artificial intelligence model as context in conjunction with the query. In another implementation, the device modifies the query in part by modifying a subquery of the query into a modified subquery sending the modified subquery to the database for processing.

At step 825, as detailed above, the device may send the valid query to the database for processing.

Procedure 800 may then end at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for lazy and demand-driven SQL query generation and optimization, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, information regarding a database;
using, by the device and based on the information regarding the database, an artificial intelligence model to generate a set of potential queries that could be processed by the database;
modifying, by the device, a query sent for processing by the database based on the set of potential queries, to form a valid query; and
sending, by the device, the valid query to the database for processing.

2. The method as in claim 1, wherein the artificial intelligence model comprises a large language model (LLM).

3. The method as in claim 1, wherein the query sent for processing by the database comprises a Structured Query Language (SQL) statement.

4. The method as in claim 1, wherein the query was sent by a user interface for processing by the database.

5. The method as in claim 1, wherein the information regarding the database comprises schema information for the database or an integrity constraint used in the database.

6. The method as in claim 1, wherein the query was generated by a natural language to Structured Query Language (SQL) converter.

7. The method as in claim 1, wherein the device modifies the query by using chain-of-thought processing to assess a subquery of the query using the set of potential queries.

8. The method as in claim 1, wherein the device modifies the query in part by providing the set of potential queries to the artificial intelligence model as context in conjunction with the query.

9. The method as in claim 1, wherein the device modifies the query in part by modifying a subquery of the query into a modified subquery sending the modified subquery to the database for processing.

10. The method as in claim 1, wherein the device executes an agent to interact with the artificial intelligence model.

11. An apparatus, comprising:
one or more network interfaces;
a processor coupled to the one or more network interfaces and configured to execute one or more processes; and
a memory configured to store a process that is executable by the processor, the process when executed configured to:
obtain information regarding a database;
use, based on the information regarding the database, an artificial intelligence model to generate a set of potential queries that could be processed by the database;
modify a query sent for processing by the database based on the set of potential queries, to form a valid query; and
send the valid query to the database for processing.

12. The apparatus as in claim 11, wherein the artificial intelligence model comprises a large language model (LLM).

13. The apparatus as in claim 11, wherein the query sent for processing by the database comprises a Structured Query Language (SQL) statement.

14. The apparatus as in claim 11, wherein the query was sent by a user interface for processing by the database.

15. The apparatus as in claim 11, wherein the information regarding the database comprises schema information for the database or an integrity constraint used in the database.

16. The apparatus as in claim 11, wherein the query was generated by a natural language to Structured Query Language (SQL) converter.

17. The apparatus as in claim 11, wherein the apparatus modifies the query by using chain-of-thought processing to assess a subquery of the query using the set of potential queries.

18. The apparatus as in claim 11, wherein the apparatus modifies the query in part by providing the set of potential queries to the artificial intelligence model as context in conjunction with the query.

19. The apparatus as in claim 11, wherein the apparatus modifies the query in part by modifying a subquery of the query into a modified subquery sending the modified subquery to the database for processing.

20. A tangible, non-transitory, computer-readable medium storing program instructions that cause a device to execute a process comprising:
obtaining, by the device, information regarding a database;
using, by the device and based on the information regarding the database, an artificial intelligence model to generate a set of potential queries that could be processed by the database;
modifying, by the device, a query sent for processing by the database based on the set of potential queries, to form a valid query; and
sending, by the device, the valid query to the database for processing.
